(19) United States
(12) Patent Application Publication
(10) Pub. No.: US 2022/0111806 A1
(43) Pub. Date: Apr. 14, 2022

(54) MAGNETIC LICENSE PLATE HOLDER SYSTEM

(71) Applicant: Lloyd A. Marks, Westfield, NJ (US)

(72) Inventor: Lloyd A. Marks, Westfield, NJ (US)

(21) Appl. No.: 17/500,497

(22) Filed: Oct. 13, 2021

Related U.S. Application Data
(60) Provisional application No. 63/091,120, filed on Oct. 13, 2020.

(51) Int. Cl. B60R 13/10

(52) U.S. Cl. CPC B60R 13/105

(57) ABSTRACT

Magnetic license plate holder systems are disclosed. Embodiments are directed to a magnetic license plate holder system including a license plate which includes a rear side and an opposing front side. The magnetic license plate holder system also includes a magnetic attachment system which includes: a rear attachment system configured to be positioned between a license plate holder and the rear side of the license plate, while facing the rear side of the license plate; and a front attachment system configured to be facing the front side of the license plate. The rear attachment system is configured to be releasably attached to the front attachment system. Each of the rear attachment system and the front attachment system includes either a magnet or a non-magnetic ferric material. At least one of the rear attachment system or the front attachment system comprises a magnet.

### CROSS REFERENCE TO RELATED APPLICATION(S)

This application claims priority to U.S. Provisional Patent Application Ser. No. 63/091,120, filed on Oct. 13, 2020, which is hereby incorporated herein by reference in its entirety.

### GOVERNMENT SPONSORSHIP

None

### FIELD OF THE INVENTION

Embodiments are in the field of license plate holders. More particularly, embodiments disclosed herein relate to magnetic license plate holder systems, including a releasable magnetic attachment system, which enable a simple, expedient, and secure coupling of a license plate to a license plate holder.

### BACKGROUND OF THE INVENTION

When a customer seeking to lease or purchase a car goes for a test drive at a car dealership, the dealer typically puts temporary plates on the car. A typical license plate sits inside an optional plate frame and the plate and plate frame (if used) are attached to the car with multiple machine screws or bolts depending on the make and model of the car.

Before a car is sold, it is generally kept on the car dealership lot with a plate frame attached to the plate holder (or car itself, if no plate holder is present or the plate holder is preferred or convenient location on the car), i.e., without a plate. The plate frame is held on with machine screws or bolts. Note that it is typical to use only two bolts (e.g., phillips head type bolts) on the top edge of a plate and plate frame to hold them onto the plate holder.

The components (e.g., screws, bolts, washers, etc.) for attaching temporary plates to the car (e.g., at a car dealership) are clumsy and often misplaced. That attachment process appears unprofessional and often wastes salesmen's time. Moreover, those steps for plate attachment are often repeated at dealerships thereby compounding and exacerbating the process.

Thus, it is desirable to provide a magnetic license plate holder system that is able to overcome the above disadvantages and which enables a simpler, expedient, and strong releasable connection of a license plate to a license plate holder.

Advantages of the present invention will become more fully apparent from the detailed description of the invention hereinbelow.

### SUMMARY OF THE INVENTION

Embodiments are directed to a magnetic license plate holder system including a license plate which includes a rear side and an opposing front side. The magnetic license plate holder system also includes a magnetic attachment system which includes: a rear attachment system configured to be positioned between a license plate holder and the rear side of the license plate, while facing the rear side of the license plate; and a front attachment system configured to be facing the front side of the license plate. The rear attachment system is configured to be releasably attached to the front attachment system. Each of the rear attachment system and the front attachment system includes either a magnet or a non-magnetic ferric material. At least one of the rear attachment system or the front attachment system comprises a magnet.

Additional embodiments and additional features of embodiments for the magnetic license plate holder system are described below and are hereby incorporated into this section.

### BRIEF DESCRIPTION OF THE DRAWINGS

The foregoing summary, as well as the following detailed description, will be better understood when read in conjunction with the appended drawings. For the purpose of illustration only, there is shown in the drawings certain embodiments. It is understood, however, that the inventive concepts disclosed herein are not limited to the precise arrangements and instrumentalities shown in the figures. The detailed description will refer to the following drawings in which like numerals, where present, refer to like items.

FIG. 1 is a drawing illustrating magnets attached to a plate holder of a car, in accordance with a first embodiment of the present invention;

FIG. 2 is a drawing illustrating magnets attached to a plate frame;

FIG. 3 is a drawing illustrating an exploded view of components (of the magnetic attachment system for a magnetic license plate holder system) for securing one magnet to the back side of the temporary plate, prior to assembly and in the order of attachment;

FIG. 4 is a drawing illustrating an assembled view of the components shown in FIG. 3 along with the license plate;

FIG. 5 is a drawing illustrating the temporary plate with two stems and logos being attached to a car, with one corner of the plate shown as attached;

FIG. 6 is a drawing illustrating the temporary plate with two stems and logos being attached to a car, with two corners of the plate shown as attached;

FIG. 7 is a drawing illustrating a rear side of a plate with four magnets;

FIG. 8 is a drawing illustrating the front of a plate with four stems and logos (with the dealer's plate frame incorporated) attached to the vehicle, ready for a test drive;

FIG. 9 is a drawing illustrating two strong (e.g. neodymium) disk magnets secured to the upper sides of the license plate holder using machine screws that pass through the disk magnets, in accordance with a second embodiment of the present invention;

FIG. 10 is a drawing illustrating an exploded view of the first 5 components to be connected that form the part of the magnetic attachment system for a magnetic license plate holder system that sits outside (on the front side of) the plate, and the last 2 elements that form the part of the magnetic attachment system (on the rear side of the plate) that is attached to the car with the machine screw;

FIG. 11 is a drawing illustrating an assembled view of the components shown in FIG. 10 along with the license plate;

FIG. 12 is a drawing illustrating the plate positioned over the license plate holder along with the outer magnets are attached to the rear side of the plate;

FIG. 13 is a drawing illustrating two strong (e.g. neodymium) disk magnets attached toward the upper edge of the license plate holder, in accordance with a third embodiment of the present invention;

FIG. 14 is a drawing illustrating an exploded view of the first 5 components to be connected that form the part of the magnetic attachment system for a magnetic license plate holder system that sits outside (on the front side of) the plate (see FIG. 15), and the last 2 elements that form part of the magnetic attachment system (on the rear side of the plate) are the magnetic disk and double-sided adhesive used to attach the magnetic disk to the license plate holder;

FIG. 15 is a drawing illustrating an assembled view of the components (for the front side of the plate) shown in FIG. 14;

FIG. 16 is a drawing illustrating the components shown in FIG. 15 being magnetically attached to the magnets that are mounted on the license plate holder, for storage until needed;

FIG. 17 is a drawing illustrating one corner of the plate being attached to the plate holder by applying the assembly shown in FIG. 15 to the plate;

FIG. 18 is a drawing illustrating two corners of the plate being attached to the plate holder by applying two of the assemblies shown in FIG. 15 to the plate;

FIG. 19 is a drawing illustrating square countersunk magnets attached to the plate frame; and

FIG. 20 is a drawing illustrating a plate holder having only two points of attachment for a license plate. There are only two holes at the top of the plate holder and two elastic resting spots on a lower (or mid) portion of the plate holder for the bottom (or mid) portion of the plate frame to rest on when the plate frame is attached to the plate holder.

### DETAILED DESCRIPTION OF THE INVENTION

It is to be understood that the figures and descriptions of the present invention may have been simplified to illustrate elements that are relevant for a clear understanding of the present invention, while eliminating, for purposes of clarity, other elements found in a typical license plate holder system. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

Before explaining at least one embodiment in detail, it should be understood that the inventive concepts set forth herein are not limited in their application to the construction details or component arrangements set forth in the following description or illustrated in the drawings. It should also be understood that the phraseology and terminology employed herein are merely for descriptive purposes and should not be considered limiting.

It should further be understood that any one of the described features may be used separately or in combination with other features. Other invented devices, systems, methods, features, and advantages will be or become apparent to one with skill in the art upon examining the drawings and the detailed description herein. It is intended that all such additional devices, systems, methods, features, and advantages be protected by the accompanying claims.

### Embodiment 1

An embodiment of the invention includes a system which provides a reversible magnetic configuration to attach a temporary license plate to a car. Some of the components of the system remain attached to the car and the other components of the system remain attached to the temporary plate so there is no way of losing them and no need to search for them.

In this embodiment, a temporary plate is fitted with strong (e.g., neodymium) disk magnets that attach to magnets on the car. Of course, the magnets must be oriented so that they attract rather than repel.

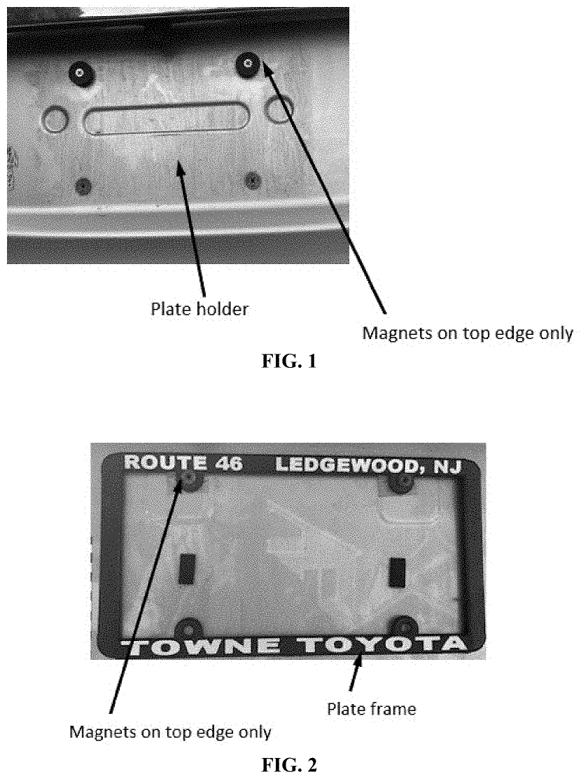

The magnets can be attached directly to the car as shown in FIG. 1 or they can be attached through a plate frame as shown in FIG. 2.

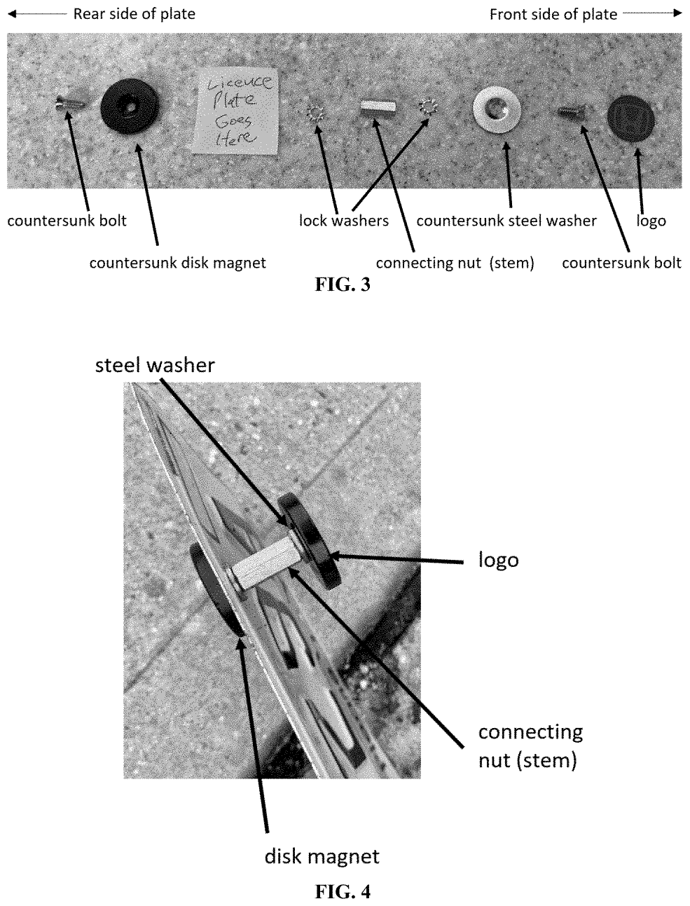

The temporary plate is fitted with magnets on its rear side. The components for securing one magnet to the rear side of the temporary plate (i.e., prior to assembly and in the order of attachment) are shown in FIG. 3. They are shown assembled in FIG. 4.

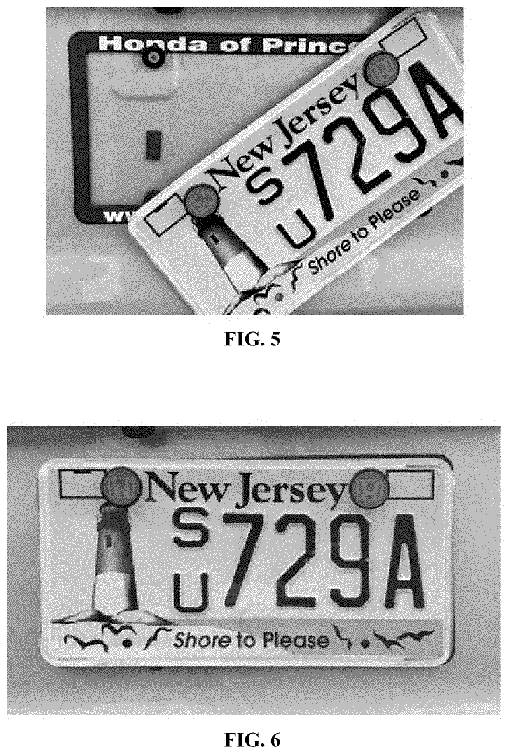

Two of these structures as viewed from the front of the plate are shown in FIGS. 5 and 6. The temporary plate with 2 stems and logos being attached to a car is shown in FIG. 5. In this figure, one corner of the plate is shown attached. In FIG. 6, both corners of the plate are attached.

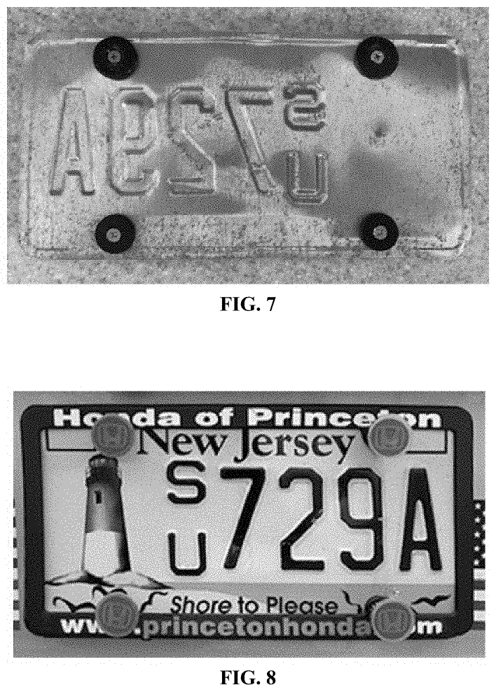

Although, this configuration provides a very secure attachment of the plate to the car, it may be desirable to have the plate attached at all four corners. FIG. 7 shows the back of a temporary plate with four magnets. It also may desirable to incorporate a plate frame with the dealers logo on the temporary plate so that the plate frame can be seen when used for a test drive. FIG. 8 shows the front of the plate with 4 stems and logos (with the dealer's plate frame incorporated) attached to the vehicle, ready for a test drive. The lower magnets on the vehicle/rear side of the plate frame are attached to the lower holes on the dealer plates that are kept on the car when it is waiting to be sold because there are only two points of attachment to the car. If a car had four points of attachment, these magnets could be attached directly to the car.

Commercially available ¾″ diameter, rubber coated, countersunk, disk, neodymium magnets may accommodate #4 screws, whereas the receiving holes in the car accommodate much larger screws, typically #10-#14. It would be possible to have ¾″ diameter magnets fabricated with larger holes, but that would remove surface area from the magnets and reduce their attractive forces. Holes may be drilled in the large screws to accommodate #4 screws and attach the ¾′ disk magnets to the screws that are screwed into the car.

There are other embodiments of the invention described below, some of which use the strong attractive force of these disk magnets to hold the temporary plate with friction only. These have been tested and work well. They are described on the following pages.

### Embodiment 2

Another embodiment of the invention also includes a system which provides a reversible magnetic configuration to attach a temporary license plate to a car. In this embodiment, the components of the system remain on the car so that there is no problem searching for them.

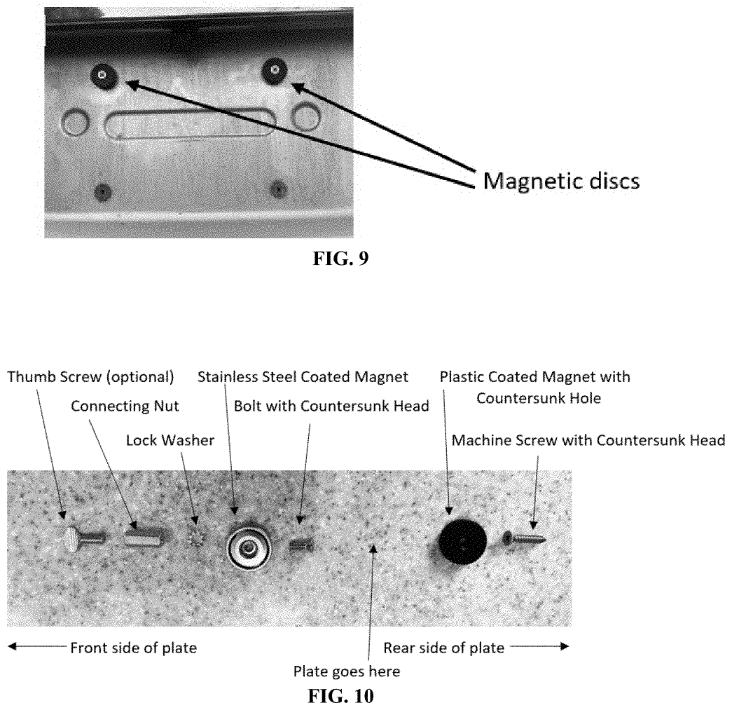

Two strong (e.g. neodymium) disk magnets are secured to the upper corners of the license plate holder (see FIG. 9) using machine screws that pass through the disk magnets. The screws have flat countersunk heads and the magnetic disks have countersunk holes. The magnets shown here are coated with rubber to protect them from the elements and are attached with two 1″ Philips head machine screws. (Some cars, e.g. Toyota RAV4, use bolts instead of screws).

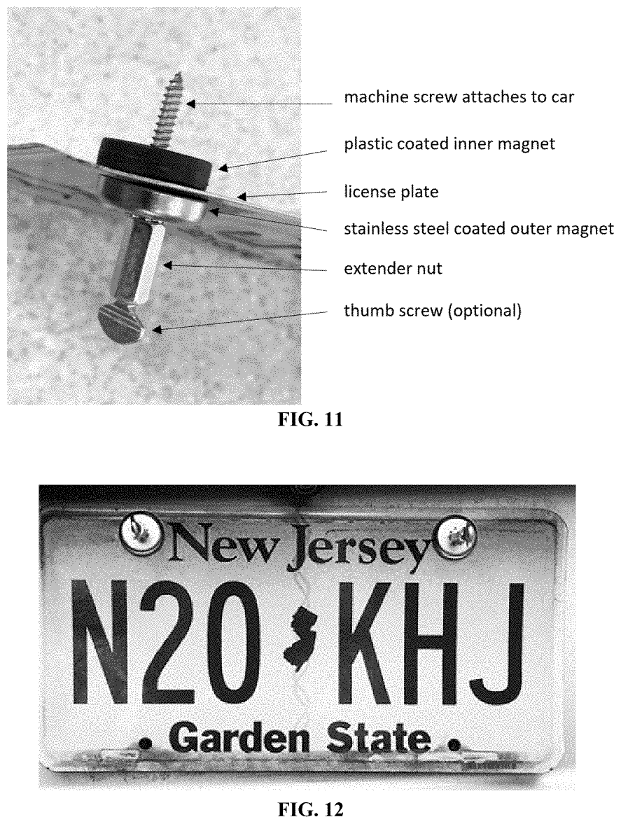

The seven components comprising the invention are shown in FIG. 10. The first five components are connected to form the part of the system which sits outside (i.e., the front side of) the plate and the last two components of the system form the part of the system that is attached to the car (i.e., at the rear side of the plate) with the machine screw (shown in FIG. 11). The magnets are oriented so that they attract one another. This assures a firm frictional grip of the license plate.

The inner and outer portions of the system are left magnetically attached for storage until needed. They would preferably be placed on all unsold cars in the car dealership lot. When the temporary plates are being attached, the outer stainless steel—coated magnets and associated components are removed from the inner magnets that are attached to the car. The plate is then positioned over the license plate holder and the outer magnets are attached at the front side of the plate. The magnetically mounted plate is shown in FIG. 12. The magnets are strong enough such that they hold the plate firmly in position for a test drive. When no longer needed, the outer magnets are removed from the plate and placed back in the storage position (i.e., magnetically attached to the inner magnets that are attached to the car). When the car is sold all components of the system are removed and can be moved to a new car.

Either the inner magnets (that are attached to the car) or the outer magnets can be replaced with steel disks (or plates) that are comprised of a material that is attracted by magnets. If that were done, there would only be a need for two magnets (e.g., one at each of two corners). This would reduce cost, but the magnetic attraction would be reduced. The replacement of either the inner or outer magnets with a steel disk (or plate) attracted by magnets can also be done on the first embodiment described above or third embodiment described below.

### Embodiment 3

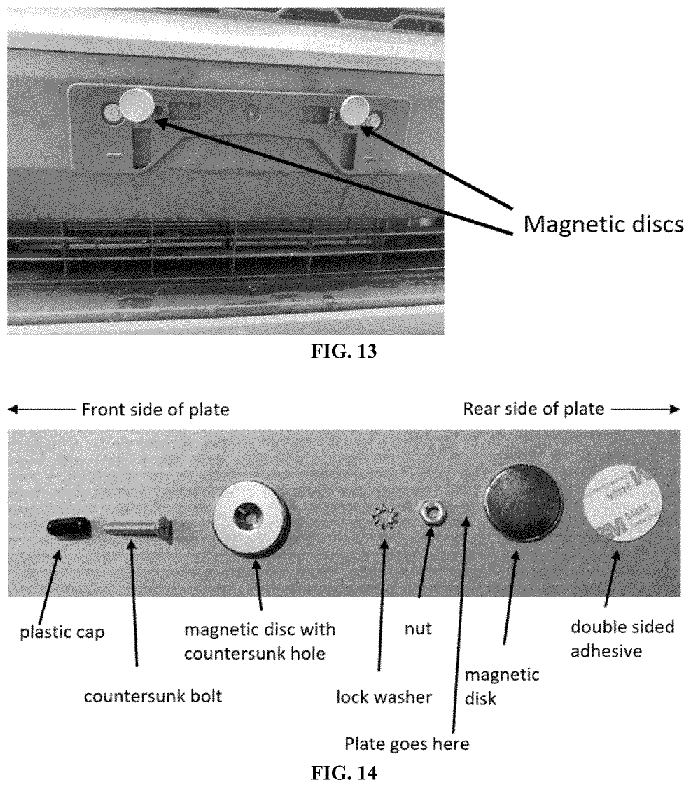

A further embodiment of the invention includes two strong (e.g. neodymium) disk magnets attached to the upper corners of the license plate holder (see FIG. 13) preferably using a strong double-sided adhesive disk such as that made by 3M.

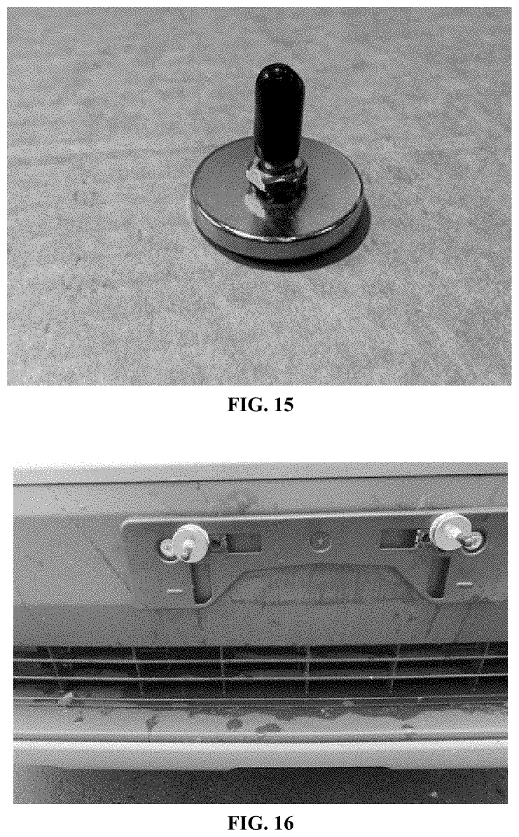

The first five components shown in FIG. 14 are assembled to form the structure shown in FIG. 15. The last two components in FIG. 14 are the magnetic disk and double-sided adhesive used to attach the magnetic disk to the license plate holder (or the bumper (or other location) of the car). The polarity of the magnets are oriented such that the magnetic disks attract rather than repel each other.

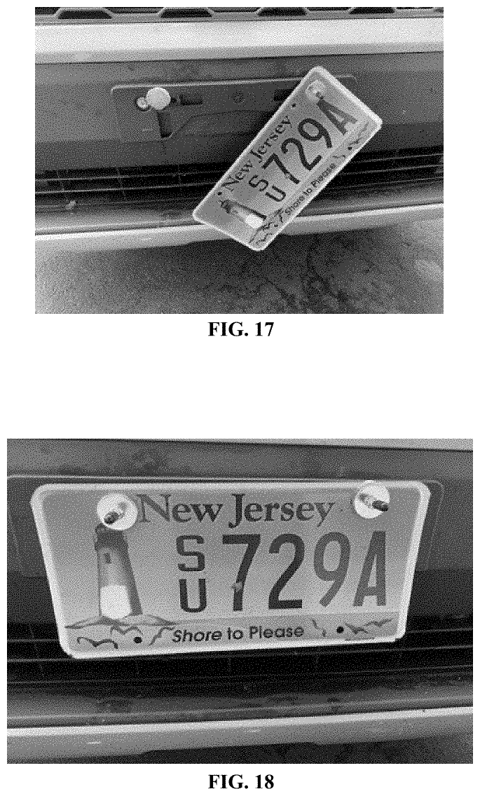

The structure shown in FIG. 15 is magnetically attached to the magnets that are mounted on the license plate holder, for storage until needed (see FIG. 16). A license plate holder such as this would preferably be placed on all unsold cars in the car dealership lot. When the temporary plates are being attached, the structures shown in FIG. 15 are removed from the magnets that are attached to the car. The plate is then positioned over the license plate holder. FIG. 17 shows one corner of the plate being attached by applying the structure in FIG. 15, and FIG. 18 shows both corners attached. The magnets are strong enough such that they hold the plate firmly in position for a test drive. When no longer needed, the structures shown in FIG. 15 are removed and placed back in the storage position shown in FIG. 16. When the car is sold all components are removed and can be placed on a new vehicle.

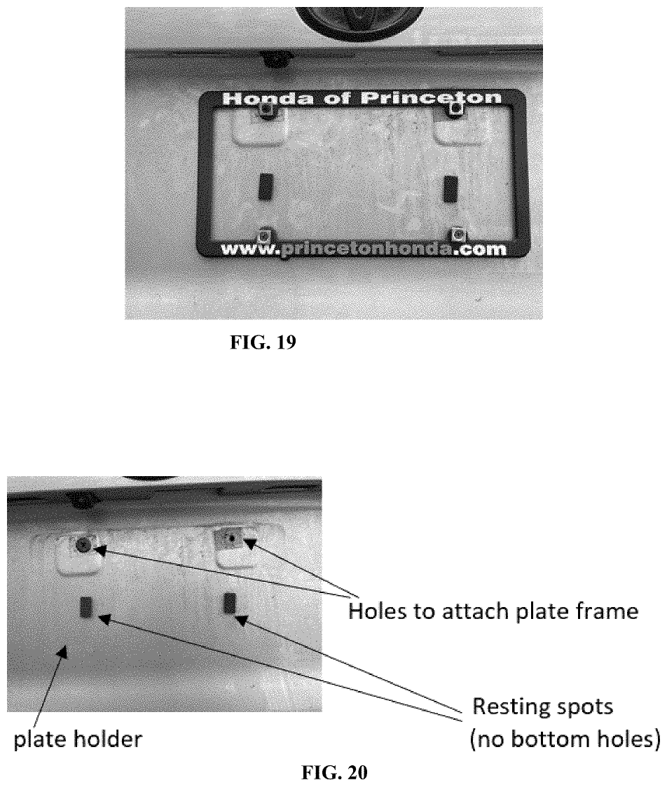

In order not to obscure the text on the empty license plate frame on an unsold car, ½″ square countersunk magnets (FIG. 19) may alternatively be employed which provide greater magnetic surface area than ½″ diameter disk magnets. Four ½″ square countersunk magnets are shown attached to the license plate frame in FIG. 19. These four square countersunk magnets would be attached to the plate frame (see FIG. 19) using machine screws or bolts which are also attached to four holes in the plate holder.

Sometimes cars only have two points of attachment at the license plate holder for a license plate or plate frame as shown in FIG. 20. In this configuration, there are only two holes at the top corners of the plate holder and may optionally have only elastic resting spots for the bottom or mid portions of the plate. In that case, two (e.g., square, countersunk) magnets are attached to the bottom of the empty plate frame with flat headed bolts, while two magnets are attached to top corners of the plate frame using machine screws or bolts which also attach to the two holes at the top corners of the plate holder. Thus, there will still be four magnetic points of attachment of the temporary plate to the empty license plate frame on the yet to be sold car. This configuration is advantageous where there are no holes at the bottom corners of the plate holder for the bottom (plate frame) bolts to attach to.

It should be apparent to one skilled in the art that it is not necessary to have an extension coupling nut and logo on the temporary plate. Simple cap nuts will suffice.

Different makes and models of cars have different ways of attaching license plates. Some use bolts and some use screws. The diameter of the holes may vary as well. The effective diameter of the screws or bolts used in embodiments of this disclosure to attach the magnets and license plate frame to the unsold cars can be made larger to accommodate larger diameter holes by wrapping Teflon tape or some other substance around the screws or bolts we choose for a particular make and model of car to increase their effective diameter and assure a secure fit.

Embodiments are directed to a magnetic license plate holder system including a license plate which includes a rear side and an opposing front side. The magnetic license plate holder system also includes a magnetic attachment system which includes: a rear attachment system configured to be positioned between a license plate holder and the rear side of the license plate, while facing the rear side of the license plate; and a front attachment system configured to be facing the front side of the license plate. The rear attachment system is configured to be releasably attached to the front attachment system. Each of the rear attachment system and the front attachment system includes either a magnet or a non-magnetic ferric material. At least one of the rear attachment system or the front attachment system comprises a magnet.

Although embodiments are described above with reference to a car/automobile, the car described in any of the above embodiments may alternatively be another type of vehicle such as a truck, SUV, van, motorcycle, etc. Such alternatives are considered to be within the spirit and scope of the present invention, and may therefore utilize the advantages of the configurations and embodiments described above.

In addition, although embodiments are described above with reference to a license plate holder used for attaching the license plate or license plate frame to the vehicle, the license plate holder described in any of the above embodiments may be omitted and any portion of the vehicle itself to which the license plate or license plate frame is desired to be attached may instead be employed for that purpose. Thus, for that purpose and for other purposes of this disclosure, “license plate holder” and “vehicle” may be used interchangeably. Such alternatives are considered to be within the spirit and scope of the present invention, and may therefore utilize the advantages of the configurations and embodiments described above.

Further, although embodiments are described above with reference to a temporary license plate (e.g., given out or used at a vehicle dealership), the temporary license plate described in any of the above embodiments may alternatively be a permanent license plate (i.e., given out or used at a dealership or somewhere other than at a dealership). Such alternatives are considered to be within the spirit and scope of the present invention, and may therefore utilize the advantages of the configurations and embodiments described above.

The method steps in any of the embodiments described herein are not restricted to being performed in any particular order. Also, structures or systems mentioned in any of the method embodiments may utilize structures or systems mentioned in any of the device/system embodiments. Such structures or systems may be described in detail with respect to the device/system embodiments only but are applicable to any of the method embodiments.

Features in any of the embodiments described in this disclosure may be employed in combination with features in other embodiments described herein, such combinations are considered to be within the spirit and scope of the present invention.

The contemplated modifications and variations specifically mentioned in this disclosure are considered to be within the spirit and scope of the present invention.

More generally, even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

1. A magnetic license plate holder system comprising:
a license plate comprising a rear side and an opposing front side; and
a magnetic attachment system comprising:
a rear attachment system configured to be positioned between a license plate holder and the rear side of the license plate, while facing the rear side of the license plate; and
a front attachment system configured to be facing the front side of the license plate;
wherein the rear attachment system is configured to be releasably attached to the front attachment system;
wherein each of the rear attachment system and the front attachment system comprises either a magnet or a non-magnetic ferric material; and
wherein at least one of the rear attachment system or the front attachment system comprises a magnet.
